(19) United States
(12) Patent Application Publication
(10) Pub. No.: US 2019/0267860 A1
(43) Pub. Date: Aug. 29, 2019

(54) STATOR FOR ROTARY ELECTRIC MACHINE

(71) Applicant: HONDA MOTOR CO., LTD., Tokyo (JP)

(72) Inventors: Masashi Inoue, Wako-shi (JP); Yoshio Moriyama, Wako-shi (JP); Tadao Nishiyama, Wako-shi (JP); Taisuke Maruyama, Wako-shi (JP)

(21) Appl. No.: 16/273,282

(22) Filed: Feb. 12, 2019

(30) Foreign Application Priority Data
Feb. 23, 2018 (JP) 2018-030987

(51) Int. Cl. H02K 3/14; H02K 3/28; H02K 3/48; H02K 1/16

(52) U.S. Cl. CPC H02K 3/14; H02K 1/165; H02K 3/48; H02K 3/28

(57) ABSTRACT

A stator for a rotary electric machine includes a stator core in which a plurality of slots are formed, and a plurality of conductive segment bodies that are bent to be insertable into the slots and connected to each other, wherein a conductive segment body group is constituted by a predetermined number of conductive segment bodies among the plurality of conductive segment bodies, conductive separate body is used in some of the predetermined number of conductive segment bodies, the plurality of conductive segment bodies of the conductive segment body group are simultaneously bent, and the conductive separate body is disposed on the side of an inner circumferential surface of the stator core.

### CROSS-REFERENCE TO RELATED APPLICATION

Priority is claimed on Japanese Patent Application No. 2018-030987, filed Feb. 23, 2018, the content of which is incorporated herein by reference.

### BACKGROUND OF THE INVENTION

### Field of the Invention

The present invention relates to a stator for a rotary electric machine.

### Description of Related Art

In a general stator for a rotary electric machine, a configuration in which a plurality of conductive segment bodies are disposed in a plurality of slots of a stator core is known. In a rotary electric machine, it is conceivable that a loss due to an eddy current (i.e., a coil eddy current loss (an eddy current loss)) will be generated in the conductive segment bodies to generate heat due to a magnetic flux from a rotor side.

In order to minimize the coil eddy current loss, a rotary electric machine using conductive separate bodies serving as conductive segment bodies is known (for example, see Japanese Unexamined Patent Application, First Publication No. 2011-147312).

### SUMMARY OF THE INVENTION

However, when conductive separate body is used as conductive segment bodies, it is conceivable that spring back is generated when the conductive separate body is molded and bent as the conductive segment bodies, and the conductive segment bodies will not be able to be easily molded.

An aspect of the present invention is directed to providing a stator for a rotary electric machine capable of suppressing spring back of conductive separate bodies.

(1) A stator for a rotary electric machine according to an aspect of the present invention includes a stator core in which a plurality of slots are formed; and a plurality of conductive segment bodies that are bent to be insertable into the slots and connected to each other, wherein a conductive segment body group is constituted by a predetermined number of conductive segment bodies among the plurality of conductive segment bodies, a conductive separate body is used in some of the predetermined number of conductive segment bodies, the plurality of conductive segment bodies are simultaneously bent to form the conductive segment body group, and the conductive separate body is disposed at a side of an inner circumferential surface of the stator core.

According to the aspect of the present invention, the conductive separate body is provided in some of the plurality of conductive segment bodies. The conductive segment body group is formed by simultaneously bending the plurality of conductive segment bodies including the conductive separate body. Accordingly, in a state in which the conductive segment body group is bent, spring back of the conductive separate body can be suppressed by the other conductive segment bodies. Accordingly, the conductive separate body can be bent along the other conductive segment bodies, and dimensions of the conductive segment body group can be accurately secured without variations.

Here, it is known that a significant coil eddy current loss in the rotary electric machine is generated in the conductive segment bodies, in particularly, on the side of an air gap. The air gap refers a gap between the inner circumferential surface of the stator core and the outer circumferential surface of the rotor core.

In the aspect of (1), the conductive separate body is disposed on the side of the inner circumferential surface of the stator core. Accordingly, occurrence of the coil eddy current loss can be appropriately suppressed by the conductive separate body, and the coil eddy current loss can be appropriately reduced.

(2) In the aspect of (1), the conductive separate body among the conductive segment body group may be disposed at a first position from the side of the inner circumferential surface of the stator core.

According to the aspect of (2), since the conductive separate body is disposed at a first position from the side of the inner circumferential surface of the stator core, the conductive separate body can be disposed at a position closest to the inner circumferential surface. Accordingly, occurrence of the coil eddy current loss can be appropriately suppressed by the conductive separate body, and the coil eddy current loss can be appropriately reduced.

(3) In the aspect of (1), the conductive separate body in the conductive segment body group may be disposed at a second position from the side of the inner circumferential surface of the stator core.

According to the aspect of (3), since the conductive separate body is disposed at a second position from the side of the inner circumferential surface of the stator core, the conductive separate body can be interposed between the other conductive segment bodies. Accordingly, in a state in which the conductive segment body group is bent, spring back of the conductive separate body can be appropriately suppressed by the other conductive segment bodies. Accordingly, the conductive separate body can be bent along the other conductive segment bodies, and a dimension of the conductive segment body group can be accurately secured without variations.

In addition, since the conductive separate body is disposed at the second position from the side of the inner circumferential surface of the stator core, the conductive separate body is disposed at a position close to the inner circumferential surface. Accordingly, occurrence of the coil eddy current loss can be appropriately suppressed by the conductive separate body, and the coil eddy current loss can be appropriately reduced.

According to the aspect of the present invention, since the plurality of conductive segment bodies including the conductive separate body can be simultaneously bent, spring back of the conductive separate body can be suppressed by the other conductive segment bodies of the conductive separate body.

### BRIEF DESCRIPTION OF THE DRAWINGS

FIG. 1 is a cross-sectional view showing a schematic configuration of a rotary electric machine according to a first embodiment of the present invention.

FIG. 2 is a plan view showing a stator for a rotary electric machine according to the first embodiment of the present invention.

FIG. 3 is an exploded perspective view showing the stator for a rotary electric machine according to the first embodiment of the present invention.

FIG. 4 is a cross-sectional view showing the rotary electric machine according to the first embodiment of the present invention taken along line IV-IV in FIG. 1.

FIG. 5A is a cross-sectional view showing a conductive segment body according to the first embodiment of the present invention.

FIG. 5B is a cross-sectional view showing conductive segment separate body according to the first embodiment of the present invention.

FIG. 6 is an enlarged plan view of a part VI in FIG. 2 showing the rotary electric machine according to the first embodiment of the present invention.

FIG. 7 is a graph for explaining coil eddy current loss of the rotary electric machine according to the first embodiment of the present invention.

FIG. 8 is a cross-sectional view showing the disposition of conductive segment bodies and conductive segment separate body of a rotary electric machine according to the second embodiment of the present invention.

### DETAILED DESCRIPTION OF THE INVENTION

Hereinafter, embodiments of the present invention will be described with reference to the accompanying drawings. Further, in the drawings used in the following description, the sizes of members may be appropriately varied. In addition, in the following description, components having the same or similar functions are designated by the same reference numerals. Thus, repeated description of these components may be omitted. In addition, a rotary electric machine 1 in the following description is simply referred to as “the rotary electric machine 1.”

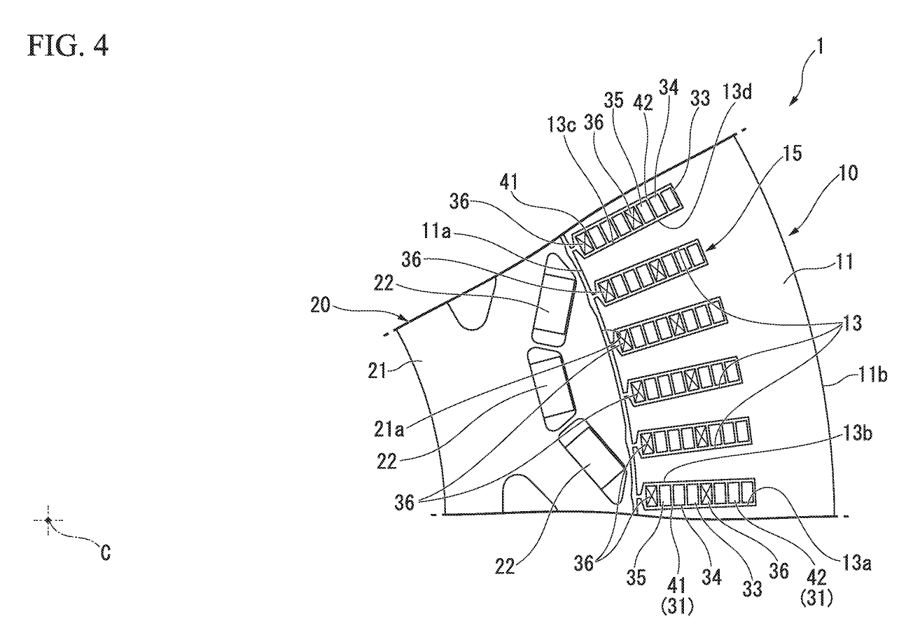

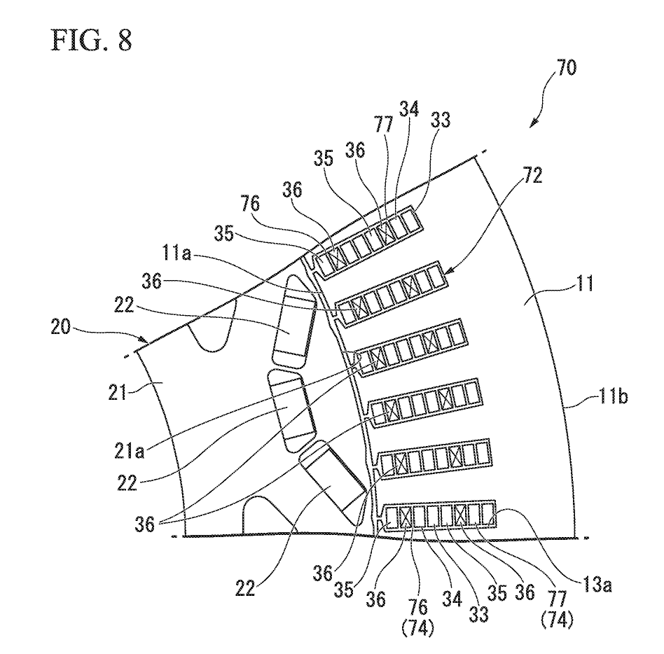

Further, in FIG. 4 and FIG. 8, a configuration of the rotary electric machine will be described while broken lines are omitted for the purpose of easy understanding.

### First Embodiment

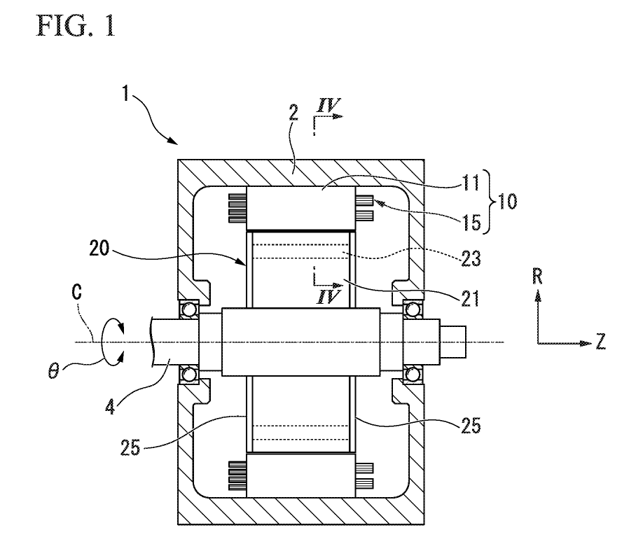

As shown in FIG. 1, the rotary electric machine 1 is a traveling motor mounted on a vehicle such as a hybrid vehicle or an electric vehicle. The rotary electric machine 1 includes a housing 2, a stator 10, a rotor 20 and a shaft (a rotary shaft) 4. The housing 2 rotatably supports the shaft 4 while accommodating the stator 10 and the rotor 20. Further, the stator 10, the rotor 20 and the shaft 4 are disposed about an axis C (predetermined axes) thereof as a common axis. Hereinafter, a direction in which the axis C extends is referred to as an axial direction, a direction perpendicular to the axis C is referred to as a radial direction, and a direction around the axis C is referred to as a circumferential direction, which will be described below.

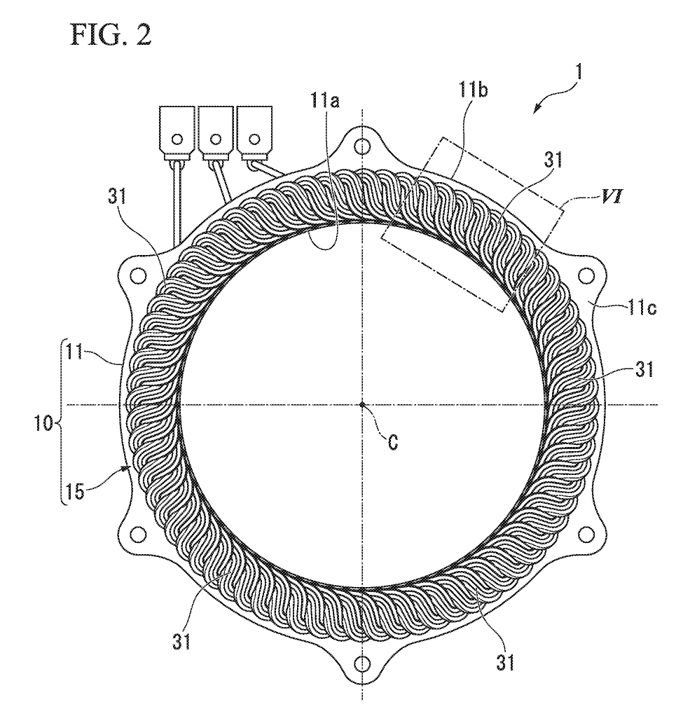

As shown in FIG. 2, the stator 10 includes a stator core 11, and coils 15 of a plurality of layers (for example, a U phase, a V phase and a W phase) mounted on the stator core 11. The stator 10 generates a magnetic field as current flows through the coils 15. The stator core 11 is formed in a cylindrical shape extending in an axis C direction (an axial direction). The stator core 11 is formed by, for example, stacking a plurality of electromagnetic steel plates in the axial direction. Further, the stator core 11 may be formed by press-forming a soft magnetic powder.

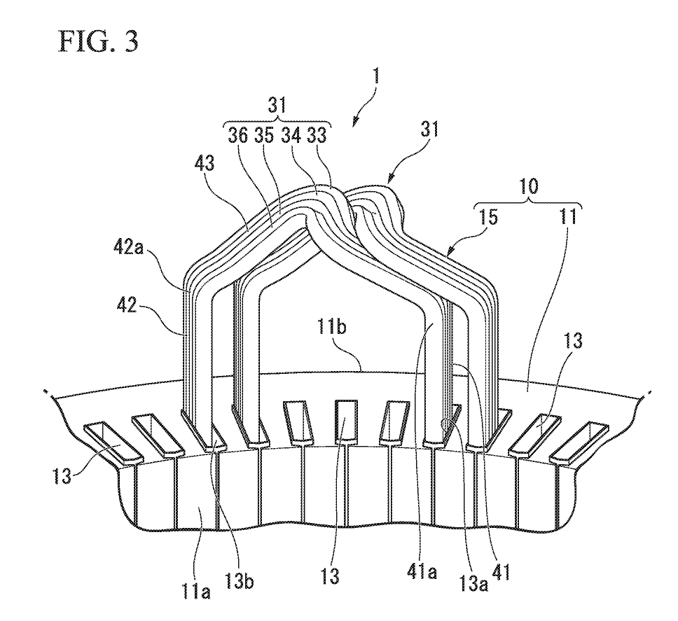

Slots 13 (see FIG. 3) into which the coils 15 are inserted are formed in the stator core 11 to be arranged in the circumferential direction.

As shown in FIG. 3 and FIG. 4, the rotor 20 is disposed inside the stator 10 in the radial direction. The rotor 20 includes a rotor core 21 and a plurality of first permanent magnets 22. The rotor core 21 is formed in a cylindrical shape uniformly extending in the axial direction and disposed to face an inner circumferential surface 11a of the stator core 11. The rotor core 21 is formed by, for example, stacking a plurality of electromagnetic steel plates in the axial direction. Further, the rotor core 21 may be formed by pressure-molding soft magnetic powder.

The shaft 4 (see FIG. 1) is provided inside the rotor core 21 through insertion, press-fitting, or the like. Accordingly, the rotor core 21 is integrated with the shaft 4 and installed to be rotatable around the axis C (also see FIG. 1).

The coils 15 include a plurality of conductive segment body groups 31. The conductive segment body groups 31 are formed by the conductive segment bodies 33 to 36 as a group by connecting a predetermined number of conductive segment bodies 33 to 36 to each other. That is, the coils 15 include a plurality of conductive segment bodies. The conductive segment body groups 31 are bent to be insertable into the slots 13.

Each of the conductive segment body groups 31 has a pair of leg sections 41 and 42 and a connecting section 43. The pair of leg sections 41 and 42 are disposed parallel to each other and formed to be insertable into the slots 13. The connecting section 43 connects one end portion 41a of the leg section 41 and one end portion 42a of the leg section 42. The conductive segment body group 31 is formed in a U shape by the pair of leg sections 41 and 42 and the connecting section 43.

Here, the conductive segment separate body (the conductive separate body) 36 is used in the predetermined number of conductive segment bodies 33 to 36 that form the conductive segment body group 31. Specifically, the conductive segment body group 31 is constituted by, for example, the first conductive segment body 33, the second conductive segment body 34, the third conductive segment body 35 and the conductive segment separate body 36.

Specifically, the conductive segment body groups 31 are gathered in a group as a bundle by connecting the first to third conductive segment bodies 33 to 35 and the conductive segment separate body 36 to each other in a state in which they are arranged in a row. The conductive segment body groups 31 are simultaneously bent in a U shape in a state in which the first to third conductive segment bodies 33 to 35 and the conductive segment separate body 36 are gathered in a group.

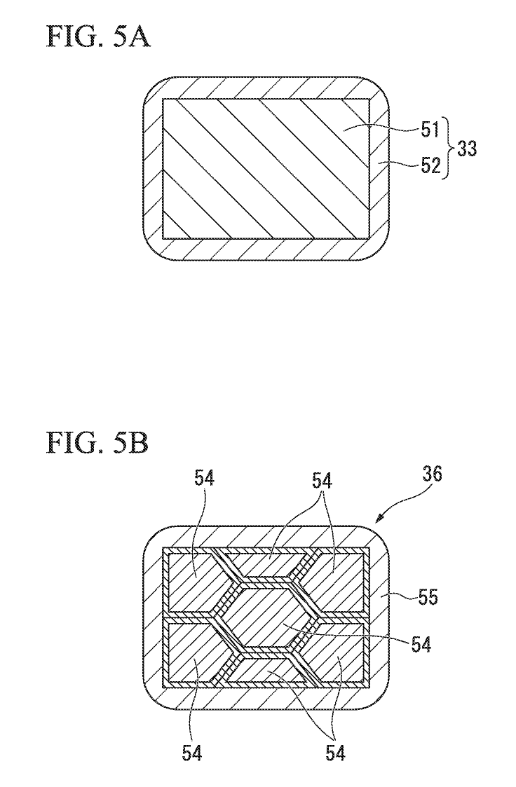

As shown in FIG. 5A, the first conductive segment body 33 is a flat wire (a single line) in which, for example a strand (a copper wire) 51 having a rectangular cross section is coated with a film of an insulating material (an enamel material) 52. As shown in FIG. 3, each of the second conductive segment body 34 and the third conductive segment body 35 is a flat wire (a single line) in which a strand (a copper wire) having a rectangular cross section is coated with a film of an insulating material (an enamel material), like the first conductive segment body 33.

As shown in FIG. 5B, the conductive segment separate body 36 is a Litz wire in which a plurality of insulated strands 54 are twisted and bundled. That is, the strands 54 of Litz wires are coated with a film of an insulating material (an enamel material) 55.

Further, the conductive segment separate body 36 may also be a stranded wire in which, for example, a plurality of strands that are not insulated are twisted and bundled. The strands of stranded wires are not coated with a film of an insulating material (an enamel material).

In this way, in the conductive segment separate body 36, the plurality of strands 54 are bundled. Accordingly, in the conductive segment separate body 36, an occupancy rate of a conductive body (copper) with respect to the first to third conductive segment bodies 33 to 35 is suppressed to a low level. For this reason, when the conductive segment body group 31 is constituted by only the conductive segment separate body 36, it is conceivable that a resistance value of the conductive segment body group 31 is increased and copper loss will not be able to be easily suppressed.

Meanwhile, it is known that coil eddy current loss of the conductive segment body groups 31 can be suppressed when the conductive segment separate body 36 is included in the conductive segment body groups 31.

Here, the conductive segment body groups 31 is constituted by the first to third conductive segment bodies 33 to 35 and the conductive segment separate body 36. That is, the conductive segment separate body 36 is included in a part of the conductive segment body group 31. Accordingly, in a state in which copper loss due to a resistance increase of the conductive segment body groups 31 is suppressed, an effect of reduction in coil eddy current loss of the conductive segment body groups 31 can be obtained.

Further, coil eddy current loss of the conductive segment body groups 31 will be described below in detail.

The conductive segment body groups 31 are simultaneously bent in a U shape in a state in which the first to third conductive segment bodies 33 to 35 and the conductive segment separate body 36 is gathered as a group.

Here, the first to third conductive segment bodies 33 to 35 are formed as a flat wire (a single line).

Accordingly, the first to third conductive segment bodies 33 to 35 can suppress spring back generated when they are bent in a U shape to a low level.

Meanwhile, the conductive segment separate body 36 is bound as the plurality of strands 54 are twisted. For this reason, the conductive segment separate body 36 cannot easily suppress the spring back generated when they are bent in a U shape, and in addition, a variation in spring back amount is large and a position thereof is not stable.

Here, the first to third conductive segment bodies 33 to 35 and the conductive segment separate body 36 is connected to each other and gathered as a group, and in this state, the conductive bodies 33 to 36 are simultaneously bent in a U shape to form the conductive segment body groups 31.

Accordingly, in a state in which the conductive segment body groups 31 are bent, spring back of the conductive segment separate body 36 can be suppressed by the first to third conductive segment bodies 33 to 35. Accordingly, the conductive separate bodies can be bent along the other conductive segment bodies, and a dimension of the conductive segment body group can be accurately secured without variations.

Returning to FIG. 3 and FIG. 4, the leg sections 41 of one side of the conductive segment body groups 31 are inserted into portions 13b of one sides of the slot 13a on the side of the inner circumferential surface 11a. In addition, the leg sections 42 of the other side of the conductive segment body groups 31 are inserted into portions 13d of the other sides of the slots 13c on the side of an outer circumferential surface 11b.

The slots 13c of the other side are formed at positions separated from the slots 13a of the one side by a predetermined number of slots.

In FIG. 4, for the purpose of easy understanding of an attachment state of the conductive segment body groups 31, the slots of one side of the slots 13 are referred to as 13a and the slots of the other side are referred to as 13c.

In this way, the leg sections 41 of one side of the conductive segment body group 31 are inserted into the portions 13b of one side of the slots 13a on the side of the inner circumferential surface 11a. Accordingly, in the slots 13a of one side, the conductive segment separate body 36 is disposed on the side of the inner circumferential surface 11a of the stator core 11. Specifically, the conductive segment separate body 36 is disposed at a first position (a first turn) from the side of the inner circumferential surface 11a of the stator core 11 in the slots 13a of one side.

In addition, in the first to third conductive segment bodies 33 to 35, in the slots 13a of one side, a fifth conductive segment body 35 is disposed at a second position (a second turn) from the side of the inner circumferential surface 11a of the stator core 11, a fourth conductive segment body 34 is disposed at a third position (a third turn), and a third conductive segment body 33 is disposed at a fourth position (a fourth turn), in sequence.

Meanwhile, the leg sections 42 of the other side are inserted into the portions 13d of the slots 13c of the other side on the side of the outer circumferential surface 11b. Accordingly, in the slots 13c of the other side, the conductive segment separate body 36 is disposed at a fifth position (a fifth turn) from the side of the inner circumferential surface 11a of the stator core 11.

In addition, in the first to third conductive segment bodies 33 to 35, in the slots 13c of the other side, a fifth conductive segment body 35 is disposed at a sixth position (a sixth turn) from the side of the inner circumferential surface 11a of the stator core 11, a fourth conductive segment body 34 is disposed at a seventh position (a seventh turn), and a third conductive segment body 33 is disposed at an eighth position (an eighth turn), in sequence.

Similarly, the other conductive segment body groups 31 are also inserted into the slots 13. Accordingly, the conductive segment separate body 36 is disposed at a first position in the plurality of slots 13 from the side of the inner circumferential surface 11a of the stator core 11. In addition, the conductive segment separate body 36 is disposed at a fifth position in the plurality of slots 13 from the side of the inner circumferential surface 11a of the stator core 11.

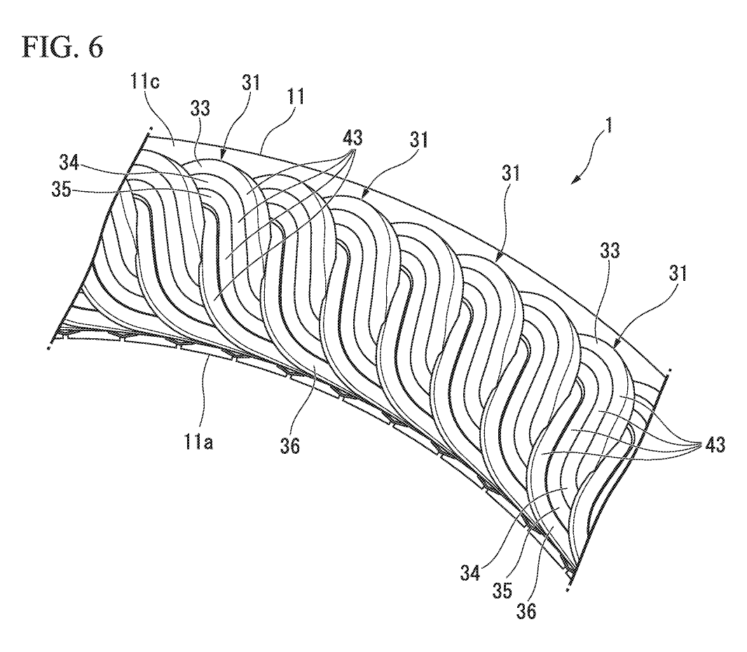

As shown in FIG. 4 and FIG. 6, the plurality of conductive segment body groups 31 are inserted into the slots 13. In this state, the leg section 41 of one side is inserted into the portion 13b of the slot 13a of one side on the side of the inner circumferential surface 11a, and the leg section 42 of the other side is inserted into the portion 13d of the slots 13 of the other side on the side of the outer circumferential surface 11b. Accordingly, in the end portion 11c of the stator core 11 in the axial direction, the connecting section 43 forms a transition section that connects from the portion 13b of the slot 13a of one side on the side of the inner circumferential surface 11a to the portion 13d of the slot 13c of the other side on the side of the outer circumferential surface 11b.

In addition, since the plurality of conductive segment body groups 31 are inserted into the slots 13, the connecting sections 43 of the plurality of conductive segment body groups 31 are disposed to be continuous in the circumferential direction. In addition, the connecting sections 43 neighboring in the circumferential direction are disposed to partially overlap each other when seen in the axial direction.

Accordingly, the coil 15 forms a coil end at the end portion 11c of the stator core 11 in the axial direction.

The conductive segment separate body 36 is disposed at the first and fifth positions in the plurality of slots 13 from the side of the inner circumferential surface 11a of the stator core 11. The reason for disposing the conductive segment separate body 36 at the first position in the plurality of slots 13 from the side of the inner circumferential surface 11a is as follows. That is, it is known that coil eddy current loss of the rotary electric machine 1 is generated remarkably at the conductive segment bodies, particularly, on the side of an air gap. The air gap refers a gap between the inner circumferential surface 11a of the stator core 11 and an outer circumferential surface 21a of the rotor core 21.

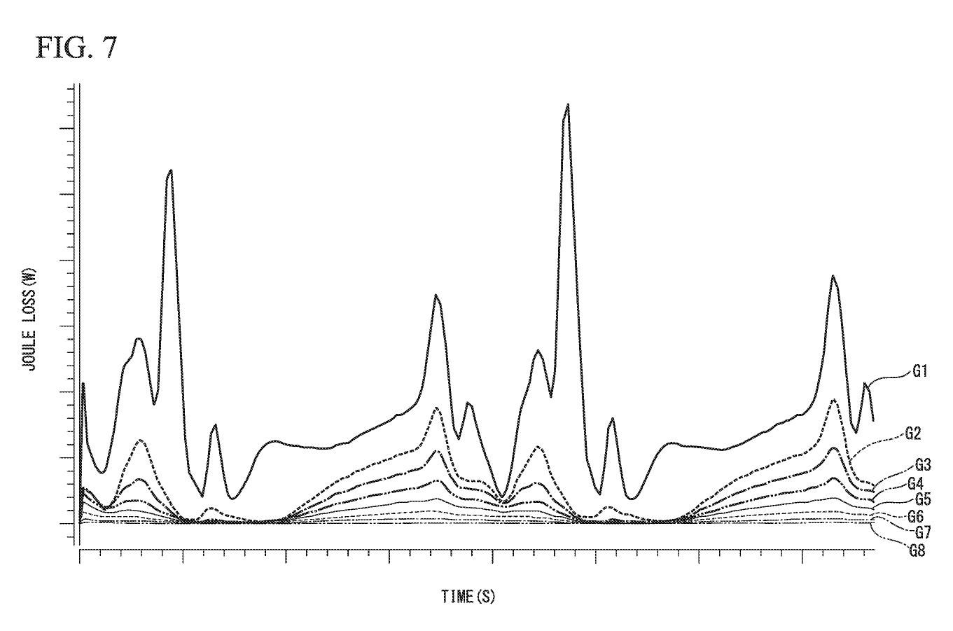

Here, the coil eddy current loss generated in the coil will be described on the basis of a graph in FIG. 7. In FIG. 7, a vertical axis shows Joule loss (Joule heat) (W) generated by coil eddy current loss. A horizontal axis shows a time (s).

Graphs G1 to G8 are graphs showing relations between Joule loss generated in conductive segment separate body disposed at the first to eighth positions in the slots 13 from the side of the inner circumferential surface 11a and times.

As will be apparent from the graphs G1 to G8, it is known that Joule loss in the graph G1 is large and the Joule loss is reduced from the graph G1 toward the graph G8.

In particular, it is known that Joule loss in the graph G1 is large, and Joule loss in the graph G2 is large next the graph G1. That is, Joule loss of the conductive segment separate body disposed on the side of the air gap is increased.

Meanwhile, it is known that Joule loss in the graphs G5 to G8 has hardly occurred. That is, Joule loss is hard to occur in the conductive segment separate body disposed on the outer circumferential surface 11b (i.e., on the side of a back yoke) of the stator core 11.

Here, as shown in FIG. 4, the conductive segment separate body 36 is disposed at the first position from the side of the inner circumferential surface 11a of the stator core 11. Accordingly, generation of coil eddy current loss can be appropriately suppressed by the conductive segment separate body 36, and coil eddy current loss can be appropriately reduced.

Incidentally, as described above, in the conductive segment separate body 36, an occupancy rate of a conductive body (copper) with respect to the first to third conductive segment bodies 33 to 35 is suppressed to a low level. For this reason, when the conductive segment body groups 31 are formed by only the conductive segment separate body 36, it is conceivable that a resistance value of the conductive segment body groups 31 is increased and copper loss will not be able to be easily suppressed.

Therefore, the conductive segment separate body 36 is included in some of the conductive segment body groups 31, and the conductive segment body group 31 is disposed at the first position from the side of the inner circumferential surface 11a of the stator core 11. Accordingly, in a state in which copper loss due to a resistance increase in the conductive segment body groups 31 is suppressed, a reduction effect of coil eddy current loss of the conductive segment body groups 31 can be obtained.

Next, a stator 70 of a second embodiment will be described on the basis of FIG. 8. Further, in the second embodiment, the same and similar components as in the stator 10 of the first embodiment are designated by the same reference numerals, and detailed description thereof will be omitted.

### Second Embodiment

As shown in FIG. 8, the stator 70 is distinguished from the stator 10 of the first embodiment in that the coil 15 of the first embodiment is substituted with a coil 72.

The coil 72 includes a plurality of conductive segment body groups 74.

Like the conductive segment body groups 31 of the first embodiment, the conductive segment body groups 74 are formed in a U shape by a pair of leg sections 76 and 77 and a connecting section (not shown).

Like the pair of leg sections 41 and 42 of the first embodiment, the pair of leg sections 76 and 77 are formed to be insertable into the slots 13.

In addition, the conductive segment body groups 74 are constituted by the first conductive segment body 33, the second conductive segment body 34, the conductive segment separate body 36 and the third conductive segment body 35. The conductive segment body groups 74 are distinguished from the conductive segment body groups 31 of the first embodiment in that the conductive segment separate body 36 is interposed (sandwiched) between the second conductive segment body 34 and the third conductive segment body 35.

In a state in which the pair of leg sections 76 and 77 are inserted into the slots 13, the third conductive segment body 35 is disposed at a first position from the side of the inner circumferential surface 11a of the stator core 11. The conductive segment separate body 36 is disposed at the second position from the side of the inner circumferential surface 11a of the stator core 11. The second conductive segment body 34 is disposed at the third position from the side of the inner circumferential surface 11a of the stator core 11. The first conductive segment body 33 is disposed at the fourth position from the side of the inner circumferential surface 11a of the stator core 11.

In addition, the third conductive segment body 35 is disposed at the fifth position from the side of the inner circumferential surface 11a of the stator core 11. The conductive segment separate body 36 is disposed at the sixth position from the side of the inner circumferential surface 11a of the stator core 11. The second conductive segment body 34 is disposed at the seventh position from the side of the inner circumferential surface 11a of the stator core 11. The first conductive segment body 33 is disposed at the eighth position from the side of the inner circumferential surface 11a of the stator core 11.

In this way, since the conductive segment separate body 36 is disposed at the second and sixth positions from the side of the inner circumferential surface 11a of the stator core 11, the conductive segment separate body 36 is interposed between the second conductive segment body 34 and the third conductive segment body 35.

Accordingly, in a state in which the conductive segment body groups 74 are bent, spring back of the conductive segment separate body 36 can be appropriately suppressed by the second conductive segment body 34 and the third conductive segment body 35. Accordingly, the conductive segment separate body 36 can be bent along the second conductive segment body 34 and the third conductive segment body 35, and a dimension of the conductive segment body groups 74 can be accurately secured without variations.

In addition, the conductive segment separate body 36 is disposed at the second positions from the side of the inner circumferential surface 11a of the stator core 11. Accordingly, the conductive segment separate body 36 is disposed at a position close to the inner circumferential surface 11a of the stator core 11. Accordingly, coil eddy current loss generated in the conductive segment body groups 74 can be appropriately suppressed by the conductive segment separate body 36, and the coil eddy current loss can be appropriately reduced.

Further, the technical scope of the present invention is not limited to the above-mentioned embodiments and various modifications may be made without departing from the scope of the present invention.

For example, while the examples in which the conductive segment bodies are disposed up to the eighth positions (the eighth turns) in the slots 13 have been described in the first embodiment and the second embodiment, there is no limitation thereto. As another example, for example, a larger or smaller amount of conductive segment bodies than the eighth turns may be disposed in the slots 13.

In addition, while the example in which the conductive segment separate body 36 is disposed at the second and sixth positions from the side of the inner circumferential surface 11a of the stator core 11 has been described in the second embodiment, there is no limitation thereto. As another example, for example, the conductive segment separate body 36 may be disposed at the third and seventh positions from the side of the inner circumferential surface 11a of the stator core 11.

In this case, the conductive segment separate body 36 is interposed (i.e., sandwiched) between the first conductive segment body 33 and the second conductive segment body 34. Accordingly, spring back of the conductive segment separate body 36 can be suppressed by the first conductive segment body 33 and the second conductive segment body 34.

Further, as another example, for example, two conductive segment separate body 36 may be disposed at the second and third positions from the side of the inner circumferential surface 11a of the stator core 11, and further, two sets of conductive segment separate body 36 may be disposed at the sixth and seventh positions. In addition, two sets of conductive segment separate body 36 may be disposed at the first and second positions from the side of the inner circumferential surface 11a of the stator core 11, and further, two sets of conductive segment separate body 36 may be disposed at the fifth and sixth positions.

In this case, the two sets of the conductive segment separate body 36 disposed at the second and third positions are interposed (i.e., sandwiched) between the first conductive segment body 33 and the third conductive segment body 35. In addition, the two sets of the conductive segment separate body 36 disposed at the sixth and seventh positions are also disposed (i.e., sandwiched) between the first conductive segment body 33 and the third conductive segment body 35. Accordingly, spring back of each of the conductive segment bodies 33 can be suppressed by the first conductive segment body 33 and the third conductive segment body 35.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A stator for a rotary electric machine comprising:
a stator core in which a plurality of slots are formed; and
a plurality of conductive segment bodies that are bent to be insertable into the slots and connected to each other,
wherein a conductive segment body group is constituted by a predetermined number of conductive segment bodies among the plurality of conductive segment bodies,
a conductive separate body is used in some of the predetermined number of conductive segment bodies,
the plurality of conductive segment bodies are simultaneously bent to form the conductive segment body group, and
the conductive separate body is disposed at a side of an inner circumferential surface of the stator core.

2. The stator for a rotary electric machine according to claim 1, wherein the conductive separate body among the conductive segment body group is disposed at a first position from the side of the inner circumferential surface of the stator core.

3. The stator for a rotary electric machine according to claim 1, wherein the conductive separate body among the conductive segment body group is disposed at a second position from the side of the inner circumferential surface of the stator core.
